(19) United States
(12) Patent Application Publication
(10) Pub. No.: US 2018/0281290 A1
(43) Pub. Date: Oct. 4, 2018

(54) THREE-DIMENSIONAL OBJECT MODELING DEVICE, METHOD OF MOLDING THREE-DIMENSIONAL OBJECT, AND CONTROL PROGRAM FOR THREE-DIMENSIONAL OBJECT MODELING DEVICE

(71) Applicant: Seiko Epson Corporation, Tokyo (JP)

(72) Inventor: Satoshi YAMAZAKI, Matsumoto (JP)

(21) Appl. No.: 15/912,938

(22) Filed: Mar. 6, 2018

(30) Foreign Application Priority Data
Mar. 28, 2017 (JP) 2017-062328

(51) Int. Cl. B29C 64/393; B29C 64/112; B33Y 10/00; B33Y 30/00; B33Y 50/02

(52) U.S. Cl. CPC B29C 64/393; B29C 64/112; B33Y 50/02; B33Y 30/00; B33Y 10/00

(57) ABSTRACT

A three-dimensional object modeling device includes: a recording head including a plurality of nozzles each of which discharges a droplet of the ink; a memory that pre-stores nozzle data for each of the plurality of nozzles, the nozzle data corresponding to a volume or an amount of increase or decrease in the volume of the discharged droplet after solidified; a modeling data generator that generates modeling data for modeling the three-dimensional object; and a discharge data generator that generates ink discharge data for instructing discharge of the ink droplet for each of the plurality of nozzles in accordance with the pre-stored nozzle data based on the generated modeling data so that a total height of a dot in a direction of layering the dot is uniformalized.

### BACKGROUND

### 1. Technical Field

The present invention relates to a modeling technique for a three-dimensional object.

### 2. Related Art

Three-dimensional (3D) printers are known as three-dimensional object modeling devices. The three-dimensional (3D) printer described in JP-A-2000-280357 discharges ink, forms a layered model body with dots formed by the discharged ink, and layers the layered model body, thereby modeling a three-dimensional object. An ink layer composed of coloring ink is formed on the surface of the three-dimensional object.

Ink is discharged through nozzles arranged in columns, and the ink through the same nozzle is discharged to the same row. The amount of discharge of ink from nozzles is slightly varied with nozzles. Although the amounts of discharge has a slight difference therebetween, when a three-dimensional object is formed, the ink through the same nozzle is discharged to the same row, and thus the slight difference is accumulated and a linear projecting portion or recessed portion may appear in the three-dimensional object. Therefore, it is desirable that the difference between the amounts of discharge be reduced, and shape reproducibility be improved.

### SUMMARY

The invention has been made to cope with the above-mentioned problem, and may be implemented according to one of the following aspects.

(1) In an aspect of the invention, there is provided a three-dimensional object modeling device that uses ink which is solidified after being discharged and becomes part of a three-dimensional object as a three-dimensional dot. The three-dimensional object modeling device includes: a recording head including a plurality of nozzles each of which discharges a droplet of the ink; a memory that pre-stores nozzle data for each of the plurality of nozzles, the nozzle data corresponding to a volume of the dot or an amount of increase or decrease in the volume of the dot after the discharged droplet of the ink is solidified; a modeling data generator that generates modeling data for modeling the three-dimensional object; and a discharge data generator that generates ink discharge data for instructing discharge of the ink droplet for each of the plurality of nozzles in accordance with the pre-stored nozzle data based on the generated modeling data so that a total height of the dots in a direction of layering the dot is uniformalized. According to the aspect, the discharge data generator generates ink discharge data for instructing discharge of the ink droplet for each of the nozzles in accordance with the pre-stored nozzle data based on the generated modeling data so that a total height of the dots in a direction of layering the dot is uniformalized, and thus, when a three-dimensional object is formed with multiple layers, the difference between the amounts of discharged ink through the nozzles can be reduced, and the shape reproducibility can be improved.

(2) In the aspect, the discharge data generator may uniformalize the total height of the dots in the direction of layering the dot by increasing or decreasing the number of the ink droplets. According to the aspect, the difference between the amounts of discharged ink can be easily reduced.

(3) In the aspect, the discharge data generator may generate a voxel in advance, to which a dot of the ink droplet is not assigned, by decreasing an amount of gradation data for halftone processing, and may enable an increase in the number of the ink droplet by assigning a dot of the ink droplet to the voxel to which a dot of the ink droplet has not been assigned. According to the aspect, a voxel to which a dot of the ink droplet is not assigned, is generated in advance by decreasing an amount of gradation data for halftone processing, and the number of the ink droplets can be easily increased by assigning the dot of the ink droplet to the voxel to which a dot of the ink droplet has not been assigned.

(4) In the aspect, the discharge data generator may uniformalize the total height of the dots in the direction of layering the dot by changing the size of the ink droplet. According to the aspect, the total height of the dots in the direction of layering the dot can be easily uniformalized by changing the size of the ink droplet.

(5) In the aspect, the discharge data generator may generates a voxel in advance, to which a dot of the ink droplet is not assigned, by decreasing an amount of gradation data for halftone processing, and may assign a dot of the ink droplet with a size in accordance with the nozzle data to the voxel to which a dot of the ink droplet has not been assigned. According to the aspect, a dot of the ink droplet with a size in accordance with the nozzle data is assigned to the voxel to which a dot of the ink droplet has not been assigned, and thus the total height of the dots in the direction of layering the dot can be easily uniformalized.

The invention can be implemented in various aspects, and for instance, can be implemented as a method of modeling a three-dimensional object, and a control program for a three-dimensional object modeling device in addition to a three-dimensional object modeling device.

### BRIEF DESCRIPTION OF THE DRAWINGS

The invention will be described with reference to the accompanying drawings, wherein like numbers reference like elements.

FIG. 1 is a functional block diagram illustrating the configuration of a three-dimensional object model system.

FIG. 2 is a perspective view schematically illustrating the internal structure of a three-dimensional object modeling device.

FIG. 3 is an explanatory diagram illustrating a recording head.

FIG. 4 is a flowchart of generation of ink discharge data executed by a CPU of a host computer.

FIG. 5 is an explanatory diagram illustrating part of a three-dimensional object when the three-dimensional object is cut along the xy plane.

FIG. 6 is a flowchart illustrating model processing performed by the three-dimensional object modeling device.

FIG. 7 is an explanatory diagram illustrating a state where ink droplets for one layer are discharged through nozzles and solidified.

FIG. 8 is an explanatory diagram illustrating a state where ink droplets for four layers are discharged through nozzles and solidified.

FIG. 9 is an explanatory diagram illustrating the processing of reducing the amount of ink in a first method.

FIG. 10 is an explanatory diagram illustrating the processing of reducing the amount of ink in a second method.

FIG. 11 is an explanatory diagram illustrating the processing of converting a dot recording rate in a third method.

FIG. 12 is an explanatory diagram illustrating the voxels to each of which a dot is assigned and the voxels to each of which a dot is not assigned in the third method.

FIG. 13 is an explanatory diagram illustrating the processing of reducing the amount of ink in the third method.

### DESCRIPTION OF EXEMPLARY EMBODIMENTS

Hereinafter, an embodiment for carrying out the invention will be described with reference to the drawings. However, in each drawing, the dimensions and scale of each component are made different from actual ones as needed. Also, the embodiments described below are preferred specific examples, and thus technically preferable various limitations are imposed. However, the scope of the invention is not limited to those embodiments unless particularly described to limit the invention in the following description.

In this embodiment, an ink-jet three-dimensional object modeling device, which discharges curable ink (an example of “liquid”) such as resin ink containing a resin emulsion, or ultraviolet curable ink to model a three-dimensional object Obj, will be illustrated and described as a three-dimensional object modeling device.

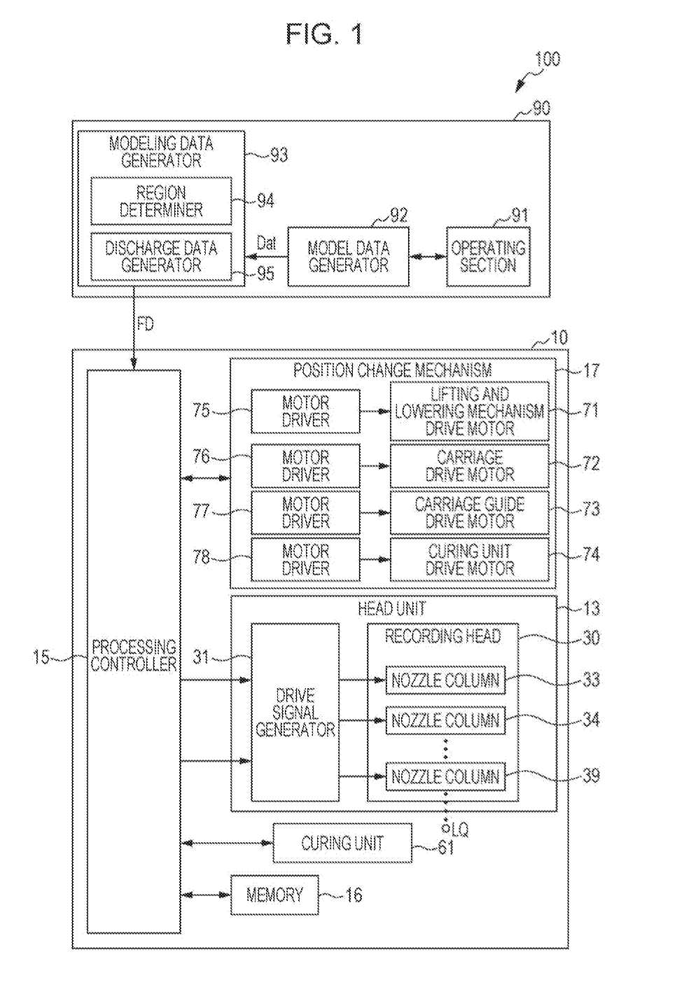

FIG. 1 is a functional block diagram illustrating the configuration of a three-dimensional object modeling system 100. As illustrated in FIG. 1, the three-dimensional object modeling system 100 includes a host computer 90 that generates data for modeling a three-dimensional object, and a three-dimensional object modeling device 10 that models a three-dimensional object. The three-dimensional object modeling device 10 discharges ink, forms a layered model body with a predetermined thickness using the dots formed by solidifying the discharged ink, and layers the model body, thereby performing model processing to model the three-dimensional object Obj. The host computer 90 executes data generation processing for generating modeling data FD that defines the shape and color of each of multiple model bodies included in the three-dimensional object Obj modeled by the three-dimensional object modeling device 10.

As illustrated in FIG. 1, the host computer 90 includes a CPU (not illustrated) that controls the operation of each component of the host computer 90, a display unit (not illustrated) such as a display, an operating part 91 such as a keyboard and a mouse, an information memory (not illustrated) that stores a control program of the host computer 90, a driver program of the three-dimensional object modeling device 10, and application programs, such as a computer aided design (CAD) software, a model data generator 92 that generates model data Dat, and a modeling data generator 93 that performs data generation processing for generating modeling data FD based on the model data Dat.

Here, the model data Dat is data that indicates the shape and color of a model representing the three-dimensional object Obj to be modeled by the three-dimensional object modeling device 10, and that is for specifying the shape and color of the three-dimensional object Obj. It is to be noted that hereinafter the color of the three-dimensional object Obj includes the manner in which the multiple colors are applied when multiple colors are applied to the three-dimensional object Obj, that is, patterns, characters, and other images represented by the multiple colors applied to the three-dimensional object Obj.

The model data generator 92 is a functional block that is implemented by executing an application program by the CPU of the host computer 90, the application program being stored in the information memory. The model data generator 92 is, for instance, a CAD application, and generates model data Dat which specifies the shape and color of the three-dimensional object Obj, based on information inputted via an operation of the operating part 91 by a user of the three-dimensional object model system 100.

It is to be noted that in this embodiment, it is assumed that the model data Dat specifies the external shape and the surface color of the three-dimensional object Obj. In other words, it is assumed that the model data Dat specifies the shape of the three-dimensional object Obj which is assumed to be hollow, that is, the contour shape of the three-dimensional object Obj. For instance, when the three-dimensional object Obj is a sphere, the model data Dat indicates the spherical shape that is the contour of the sphere. However, the invention is not limited to such aspects and it is sufficient that the model data Dat include information that can identify at least the external shape of the three-dimensional object Obj. For instance, in addition to the external shape and color of the three-dimensional object Obj, the model data Dat may specify the internal shape and material of the three-dimensional object Obj. For instance, a data format, such as an additive manufacturing file format (AMF) and a standard triangulated language (STL) can be exemplified as the model data Dat.

The model data generator 93 is a functional block that is implemented by executing a driver program of the three-dimensional object modeling device 10 by the CPU of the host computer 90, the driver program being stored in the information memory. The model data generator 93 is a model region determiner, and performs data generation processing for generating modeling data FD that defines the shape and color of a model body to be formed by the three-dimensional object modeling device 10, based on the model data Dat generated by the model data generator 92.

In the following, it is assumed that the three-dimensional object Obj is modeled by layering Q layered model bodies (Q is a natural number satisfying Q 2). Also, in the following, processing of forming a model body performed by the three-dimensional object modeling device 10 is referred to as layer processing. In other words, model processing for modeling the three-dimensional object Obj performed by the three-dimensional object modeling device 10 includes the layer processing for Q times.

In order to generate Q pieces of modeling data FD that define the shape and color of Q model bodies each having a predetermined thickness, the model data generator 93 first generates sectional model data that has a one-to-one correspondence with each model body by slicing a three-dimensional shape indicated by the model data Dat every predetermined thickness Lz. Here, the sectional model data is data that indicates the shape and color of each section body obtained by slicing the three-dimensional shape indicated by the model data Dat. However, the sectional model data may be data that includes the shape and color of the section when the three-dimensional shape indicated by the model data Dat is sliced. The thickness Lz corresponds to the length of the dots formed by solidifying ink in the height direction.

Next, in order to form a model body corresponding to the shape and color indicated by the sectional model data, the model data generator 93 determines the arrangement of dots to be formed by the three-dimensional object modeling device 10, and outputs a result of the determination as the model data. In other words, the modeling data FD refers to data that, when the shape and color indicated by the sectional model data are expressed as a set of dots by subdividing the shape and color into a lattice, specifies the type of ink for forming each of multiple dots. The modeling data FD may include data that indicates the size of dots. Here, each dot is a three-dimensional object that is formed by solidifying the ink discharged at a time. In this embodiment, for the sake of convenience, each dot is a rectangular parallelepiped or a cube that has a predetermined thickness Lz and a predetermined volume. Also, in this embodiment, the volume and size of each dot are determined by factors including a pitch of the nozzle through which ink is discharged, a discharge interval of ink, and a viscosity of ink.

The model data generator 93 includes a color region determiner 94, and a discharge data generator 95. The color region determiner 94 determines a region in which dots formed by the coloring ink are arranged among the dots to be formed by the three-dimensional object modeling device 10. The color region determiner 94 determines a color region in which coloring is performed by discharging coloring ink to the surface of a set of dots formed by modeling ink, so as to reduce the difference in the depth in a normal direction of the surface of the three-dimensional object Obj. For instance, it is assumed that the variation in the depth from the surface of a color region is constant. The discharge data generator 95 generates modeling ink discharge data for discharging modeling ink, and coloring ink discharge data for discharging coloring ink. When generating the coloring ink discharge data, the discharge data generator 95 performs halftone processing.

As described above, the model data Dat according to this embodiment specifies the external shape (contour shape) of the three-dimensional object Obj. For this reason, when a three-dimensional object Obj in the shape indicated by the model data Dat is faithfully modeled, the shape of the three-dimensional object Obj is a hollow shape with the only contour having no thickness. However, when a three-dimensional object Obj is modeled, it is preferable to determine the shape inside the three-dimensional object Obj in consideration of the strength of the three-dimensional object Obj. Specifically, when a three-dimensional object Obj is modeled, it is preferable that part or all of the inside of the three-dimensional object Obj have a solid structure. For this reason, the model data generator 93 according to this embodiment generates modeling data FD indicating that part or all of the inside of the three-dimensional object Obj has a solid structure regardless of whether or not the shape specified by the model data Dat is a hollow shape.

It is to be noted that depending on the shape of the three-dimensional object Obj, no dot is present in the (n−1)th layer which a lower layer of the dots in the nth layer. In such a case, even when a dot in the nth layer is attempted to be formed, the dot may fall downward. Thus, when “q≥2”, in order to form a dot for constructing a model body at a position where the dot is to be formed originally, it is necessary to provide a supporter below the dot for supporting the dot. In this embodiment, similarly to the three-dimensional object Obj, a supporter is formed by dots composed of solidified ink. Thus, in this embodiment, in addition to the three-dimensional object Obj, the modeling data FD includes data for forming dots to form a supporter which is necessary when the three-dimensional object Ob is modeled. That is, in this embodiment, the model body includes both a portion in the three-dimensional object Obj to be formed by the qth layer processing, and a portion in the supporter to be formed by the qth layer processing. In other words, the modeling data FD includes data in which the shape and color of a portion formed as a model body in the three-dimensional object Obj are represented as a set of dots, and data in which the shape of a portion formed as a model body in the supporter are represented as a set of dots. The model data generator 93 according to this embodiment determines whether or not a supporter has to be provided for forming dots, based on the sectional model data or the model data Dat. When a result of the determination is affirmative, the model data generator 93 generates modeling data FD for providing a supporter, in addition to the three-dimensional object Obj. It is to be noted that it is preferable that the supporter be composed of a material that can be easily removed after the formation of the three-dimensional object Obj, for instance, water-soluble ink. The ink for forming dots used for the supporter is called “support ink”.

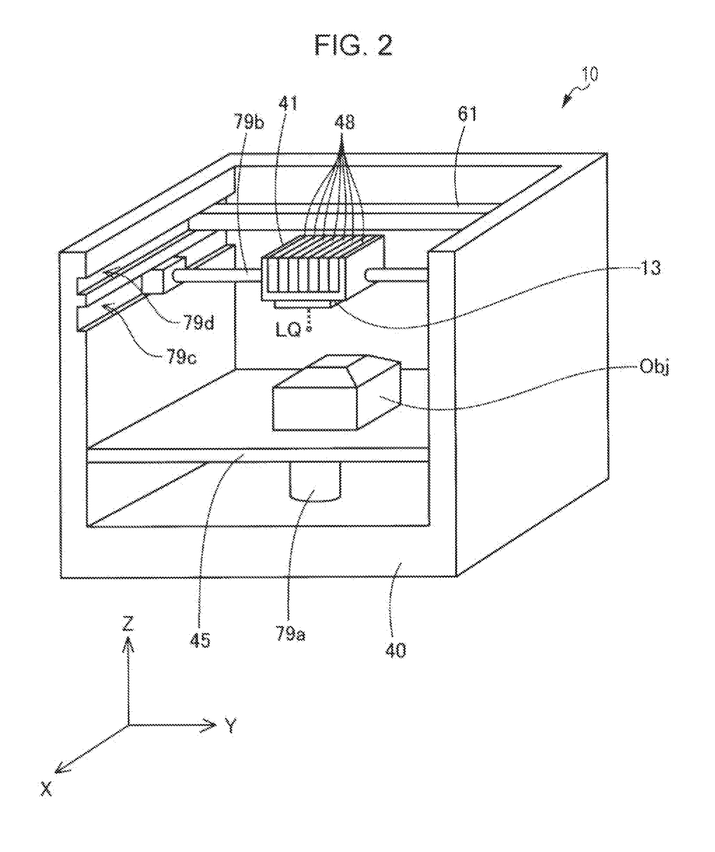

FIG. 2 is a perspective view schematically illustrating the internal structure of the three-dimensional object modeling device 10. Hereinafter, a description is given with reference to FIG. 1 in addition to FIG. 2. As illustrated in FIGS. 1 and 2, the three-dimensional object modeling device 10 includes a housing 40, a model table 45, a processing controller 15 (an example of “model controller”) that controls the operation of each component of the three-dimensional object modeling device 10, a head unit 13, a curing unit 61, a carriage 41, a position change mechanism 17, and a memory 16 that stores a control program of the three-dimensional object modeling device 10 and other various pieces of information. The carriage 41 is equipped with the head unit 13 and seven ink cartridges 48. The head unit 13 includes a recording head 30 including nozzle columns 33 to 39, and discharges ink liquid droplet LQ to the model table 45 through the nozzle columns 33 to 39. The curing unit 61 is for curing the ink discharged onto the model table 45. The position change mechanism 17 changes the positions of the carriage 41, the model table 45, and the curing unit 61 with respect to the housing 40. The processing controller 15 and the model data generator 93 each serve as a system controller that controls the operation of each component of the three-dimensional object model system 100.

The curing unit 61 is a component that cures the ink discharged onto the model table 45, and for instance, a light source for irradiating ultraviolet curing ink with ultraviolet rays, and a heater for heating resin ink can be illustrated. When the curing unit 61 is a light source of ultraviolet rays, the curing unit 61 is provided, for instance, on the upper side (in +Z direction) of the model table 45. On the other hand, when the curing unit 61 is a heater, the curing unit 61 may be provided, for instance, on the inner side of the model table 45 or on the lower side of the model table 45. Hereinafter, a description is given under the assumption that the curing unit 61 is a light source of ultraviolet rays and the curing unit 61 is positioned in +Z direction of the model table 45.

The seven ink cartridges 48 are provided to have a one-to-one correspondence with totally seven types of ink consisting of the modeling ink with six colors for modeling the three-dimensional object Obj, and supporting ink (support ink) for forming a supporter. Each of the ink cartridges 48 is filled with ink of a type corresponding to the ink cartridge 48. The modeling ink with five colors for modeling the three-dimensional object Obj includes chromatic color ink having a chromatic color material component, achromatic color ink having an achromatic color material component, and clear (CL) ink having a less content of color material component per unit weight or unit volume as compared with the chromatic color ink and the achromatic color ink. In this embodiment, inks in three colors of cyan (CY), magenta (MG), and yellow (YL) are used as the chromatic color ink. Also, in this embodiment, ink of white (WT) and ink of black (K) are used as the achromatic color ink. In this embodiment, chromatic color ink and black ink are collectively called “coloring ink”. The white ink according to this embodiment is an ink that, when the white ink is irradiated with light having a wavelength belonging to a wavelength range (approximately 400 nm to 700 nm) of visible light, reflects light with a predetermined ratio or higher in the light with which the white ink is irradiated. It is to be noted that “reflects light with a predetermined ratio or higher” is synonymous with “absorbs or transmits light with less than a predetermined ratio”, and refers to a situation when a ratio of the quantity of light reflected by the white ink to the quantity of light with which the white ink is irradiated is higher than or equal to a predetermined ratio, for instance. In this embodiment, the “predetermined ratio” may be, for instance, any ratio 30% or higher and 100% or lower, and is preferably any ratio of 50% or higher, and is more preferably any ratio of 80% or higher. In this embodiment, the clear ink is a highly transparent ink having a less content of color material component as compared with the chromatic color ink and the achromatic color ink.

It is to be noted that each ink cartridge 48 may be provided somewhere else in the three-dimensional object modeling device 10 other than in the carriage 41.

As illustrated in FIGS. 1 and 2, the position change mechanism 17 includes a lifting and lowering mechanism drive motor 71, carriage drive motors 72, 73, a curing unit drive motor 74, and motor drivers 75 to 78. The position change mechanism 17 receives an instruction from the processing controller 15, and drives a model table lifting and lowering mechanism 79a that lifts and lowers the model table 45 in +Z direction and −Z direction (hereinafter, +Z direction and −Z direction may be collectively referred to as the “Z-axis direction”). The carriage drive motor 72 receives an instruction from the processing controller 15, and moves the carriage 41 along a guide 79b in +Y direction and −Y direction (hereinafter, +Y direction and −Y direction may be collectively referred to as the “Y-axis direction”). The carriage drive motor 73 receives an instruction from the processing controller 15, and moves the carriage 41 along a guide 79c in +X direction and −X direction (hereinafter, +X direction and −X direction may be collectively referred to as the “X-axis direction”). The curing unit drive motor 74 receives an instruction from the processing controller 15, and moves the curing unit 61 along a guide 79d in +X direction and −X direction. The motor driver 75 drives the lifting and lowering mechanism drive motor 71, the motor drivers 76, 77 drive the carriage drive motors 72, 73, and the motor driver 78 drives the curing unit drive motor 74.

The head unit 13 includes a recording head 30 and a driving signal generator 31. The driving signal generator 31 receives an instruction from the processing controller 15, and generates various signals including a driving waveform signal for driving the recording head 30, and a waveform specification signal, and outputs these generated signals to the recording head 30. A description of the driving signal generator 31 and the driving waveform signal will be omitted.

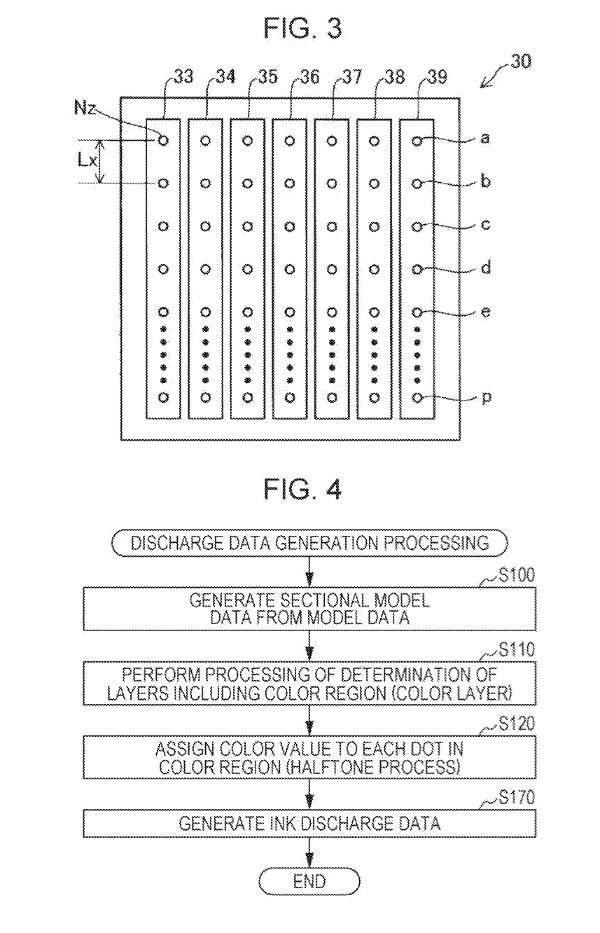

FIG. 3 is an explanatory diagram illustrating the recording head 30. The recording head 30 includes seven nozzle columns 33 to 39. Each of the nozzle columns 33 to includes multiple nozzles Nz provided at intervals of pitch Lx. The nozzle columns 33 to 35 have nozzles Nz for discharging the chromatic color inks (cyan, magenta, yellow) each of which is coloring ink. The nozzle columns 36, 37 has nozzles Nz for discharging ink of the black and ink of white (also called “white ink”) which are achromatic color ink. The nozzle column 38 has nozzles Nz for discharging of clear ink. The nozzle column 39 has nozzles Nz for discharging the support ink. Here, all inks except the support ink are used as the modeling ink, and the chromatic color ink and the black ink are used as the coloring ink. Therefore, the first nozzle, through which the modeling ink is discharged, includes the nozzles Nz in the nozzle columns 33 to 38, and the second nozzle, through which the coloring ink is discharged, includes the nozzles Nz in the nozzle columns 33 to 36, and 38.

In this embodiment, as illustrated in FIG. 3, the nozzles Nz in the nozzle columns 33 to 39 are arranged so as to be aligned in a row in the X-axis direction. However, for instance, part of the nozzles Nz (for instance, even-numbered nozzles Nz) and the other part of the nozzles Nz (for instance, odd-numbered nozzles Nz) may be at different positions in the Y-axis direction, that is, so-called in a staggered configuration among multiple nozzles Nz included in the nozzle columns 33 to 39. Also, the interval (pitch Lx) between nozzles Nz in the nozzle columns 33 to 39 may be set as appropriate according to a dot per inch (DPI).

The processing controller 15 includes a central processing unit (CPU) and a field-programmable gate array (FPGA), and controls the operation of each component of the three-dimensional object modeling device 10 by operating the CPU in accordance with the control program stored in the memory 16. The memory 16 includes an electrically erasable programmable read-only memory (EEPROM) which is a type of a non-volatile semiconductor memory that stores the modeling data FD supplied from the host computer 90; a random access memory (RAM) that temporarily stores data necessary for performing various types of processing, such as model processing to model a three-dimensional object Obj, or allows a control program for controlling each component of the three-dimensional object modeling device 10 to be temporarily loaded so as to perform various types of processing, such as the model processing; and a PROM which is a type of a non-volatile semiconductor memory that stores control programs. The memory 16 stores nozzle data for each of nozzles, the nozzle data corresponding to the volume of a dot after an ink droplet is solidified, or the amount of increase or decrease in the volume from a reference. The volume of a dot after an ink droplet is solidified, or the amount of increase or decrease in the volume from a reference are measured in advance.

The processing controller 15 controls the operation of the head unit 13 and the position change mechanism 17 based on the modeling data FD supplied from the host computer 90, thereby controlling the execution of the model processing to model the three-dimensional object Obj on the model table 45 according to the model data Dat. Specifically, the processing controller 15 first stores the model data FD supplied from the host computer 90 in the memory 16. Next, the processing controller 15 controls the driving signal generator 31 of the head unit 13, generates various signals including a driving waveform signal for driving the recording head 30 and a waveform specification signal, and outputs these generated signals to the recording head 30, based on various types of data such as the modeling data FD stored in the memory 16. Also, the processing controller 15 generates various signals for controlling the motor drivers 75 to 78, outputs these generated signals to the motor drivers 75 to 78, and controls the relative position of the head unit 13 with respect to the model table 45, based on various types of data such as the modeling data FD stored in the memory 16.

In this manner, the processing controller 15 controls the relative position of the head unit 13 with respect to the model table 45 via control of the motor drivers 75, 76, and 77, and controls the relative position of the curing unit 61 with respect to the model table 45 via control of the motor drivers 75 and 78. In addition, the processing controller 15 controls presence and absence of discharge of ink through the nozzles Nz, the amount of discharge of ink, and the timing of discharge of ink via control of the head unit 13. Thus, the processing controller 15 forms dots on the model table 45 while adjusting the size of dots and arrangement of dots which are formed by the ink discharged onto the model table 45, and controls the execution of layer processing for forming a model body by curing the dots formed on the model table 45. In addition, the processing controller 15 repeatedly performs the layer processing to layer a new model body on a model body already formed, thereby controlling the execution of model processing for forming a three-dimensional object Obj corresponding to the model data Dat.

FIG. 4 is a flowchart of generation of ink discharge data executed by the CPU of the host computer 90. The processing is executed by a CPU corresponding to the model data generator 93, after the model data Dat is created by the model data generator 92 of the host computer 90. When the processing is started, in step S100, the model data generator 93 generates sectional model data from the model data Dat. In step S110 subsequent to step S100, the region determiner 94 determines a color region. Specifically, the color region determiner 94 determines dots DT to be composed of coloring ink among the dots DT included in each layer. It is to be noted that the region determiner 94 determines not only a color region, but also a transparent layer, a shield layer, and a model layer. In step S120 subsequent to step S110, the discharge data generator 95 performs halftone processing for assigning a color value to each dot. In the subsequent to step S170, the discharge data generator 95 generates ink discharge data in a format corresponding to the modeling data FD.

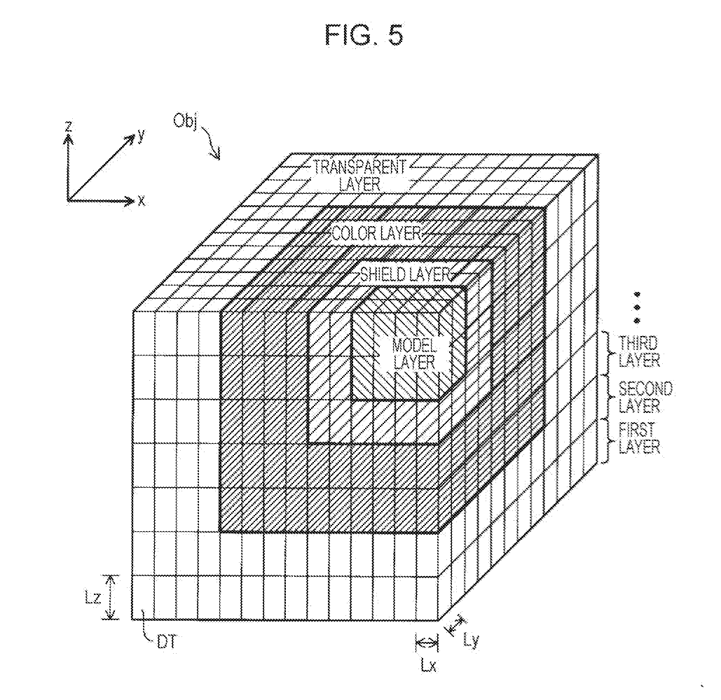

FIG. 5 is an explanatory diagram illustrating part of the three-dimensional object Obj when the three-dimensional object Obj is cut along the xy plane. The model data generator 93 forms the shape of the three-dimensional object Obj as a set of dots DT each having a three-dimensional shape with length, width, height of Ly, Lx, Lz. In this embodiment, Ly:Lx:Lz is equal to 1:1:2. Here, Lx is the length of each dot DT in the x direction, and is equal to the pitch of the nozzles Nz. Ly is the length of each dot DT in the y direction, and is equal to a movement length of the recording head 30 according to a discharge interval of ink. Lz is equal to the length of each dot DT in the z direction. Lz is determined by the viscosity and amount of ink of which each dot is composed. The sectional model data of each layer is formed, for instance, as a set of dots DT disposed two-dimensionally in the x direction and the y direction. It is to be noted that each dot DT forms one of the later-described transparent layer, color layer (color region), shield layer, and model layer.

The three-dimensional object Obj has a model layer at the center. The model layer forms the main shape of the three-dimensional object Obj. The model layer may be formed using any ink other than the support ink. A shield layer is formed on the surface of the model layer. The shield layer is for shielding the model layer to make the color thereof invisible, and is composed of white ink. The thickness of the shield layer is L3. A color layer is formed on the surface of the shield layer. The color layer is a color region, and a color is applied to the three-dimensional object Obj. The color layer is composed of chromatic color ink and white ink. Here, when the gradation of the chromatic color ink is low, a region, to which the chromatic color ink is not applied, may occur. Since the chromatic color ink also forms the shape, a shape loss may occur in the region to which the chromatic color ink is not applied. The white ink fills the region to which the chromatic color ink is not applied, and reduces the possibility of occurrence of a shape loss. It is to be noted that clear ink may be used instead of the white ink. The thickness of the color layer is L2. A transparent layer is for protecting the color layer, and is composed of the clear ink which is a transparent ink. The thickness of the transparent layer is L1. It is to be noted that the transparent layer may not be provided.

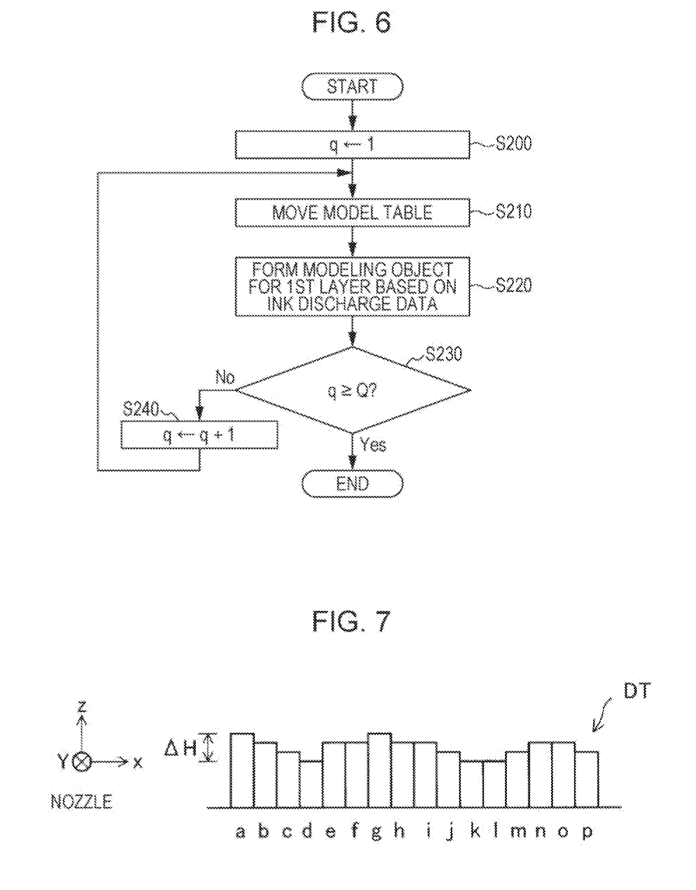

The host computer 90 outputs generated modeling data FD to the three-dimensional object modeling device 10 at a predetermined timing. FIG. 6 is a flowchart illustrating model processing performed by the three-dimensional object modeling device 10. The processing is started when the three-dimensional object modeling device 10 receives the modeling data FD from the host computer 90. When the processing of FIG. 6 is started, the processing controller 15 substitutes 1 for variable q (step S200), where q is a variable that indicates the current layer number, and q=1 indicates the 1st layer from the lower side in the z direction. In the subsequent step S210, the processing controller 15 instructs the position change mechanism 17 to move the model table 45 to a height at which a model body of the 1st layer is formed. In step S220, the processing controller 15 forms a model body of the 1st layer based on ink discharge data (modeling data FD). Specifically, the processing controller 15 forms dots DT by discharging various types of ink onto the model table 45 through the nozzles Nz of the nozzle columns 33 to 38, and subsequently, solidifying the ink using the curing unit 61. In step S230, the processing controller 15 determines whether or not q≥Q. Q is the number of model body layers that form the three-dimensional object Obj. When q≥Q, generation of all the model bodies of the 1st to Qth layers is ended, and so generation of the three-dimensional object Obj is completed, thus the processing controller 15 completes the processing. On the other hand, when q<Q, the flow proceeds to step S240, and 1 is added to the variable q and the flow proceeds to step S210. In step S210 for the second time or later, the position change mechanism 17 lowers the model table 45 by the height Lz of the dot DT. Subsequently, the flow proceeds to step S220, and the same processing is repeated until q Q is satisfied in step S230.

FIG. 7 is an explanatory diagram illustrating a state where ink droplets for one layer are discharged through the nozzles and solidified. In this example, each solidified dot is illustrated by a rectangle. The characters a to p under the dots are each a symbol for identifying a nozzle Nz through which ink is discharged. Although 16 dots are illustrated in the example of FIG. 7, 16 dots are an example. The height of each dot corresponds to the amount of discharged ink at a time. Although the difference of the amounts of discharged ink between the nozzles is slight and the height of each dot has not much difference, the height of each dot is exaggeratedly illustrated in FIG. 7. The highest dot (nozzle a) and the lowest dot (nozzle d) generate a difference of ΔH therebetween.

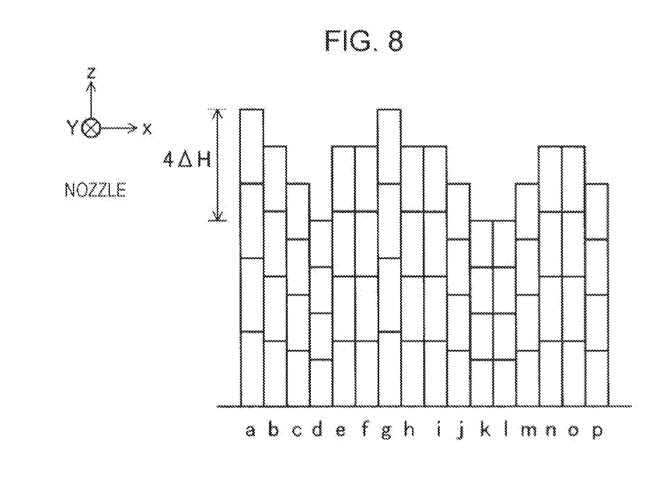

FIG. 8 is an explanatory diagram illustrating a state where ink droplets for four layers are discharged through nozzles and solidified. The size of each of ink droplets discharged through the nozzles a to p does not change when forming the dots of any layer. Therefore, when many layers are formed, the difference of ΔH illustrated in FIG. 7 is accumulated. In FIG. 8, since the ink droplets for four layers are discharged, and solidified, a difference of 4ΔH occurs between the dots formed by solidified ink droplets which have been discharged through the nozzle a, and the dots formed by solidified ink droplets which have been discharged through the nozzle d. The difference increases as more layers are formed. It is to be noted that accumulation of ΔH is noticeable when layers are formed by ink of a single color. This is because for the case of ink of 2 colors or more, it is probabilistically unlikely that the amounts of ink droplets, of the ink forming dots at the same position, discharged through the nozzles Nz are equally low or equally high, and the dots of ink are distributed by the halftone processing, and therefore accumulation of ΔH is unlikely to occur. Hereinafter, a method of reducing the accumulation of ΔH will be described.

First Method

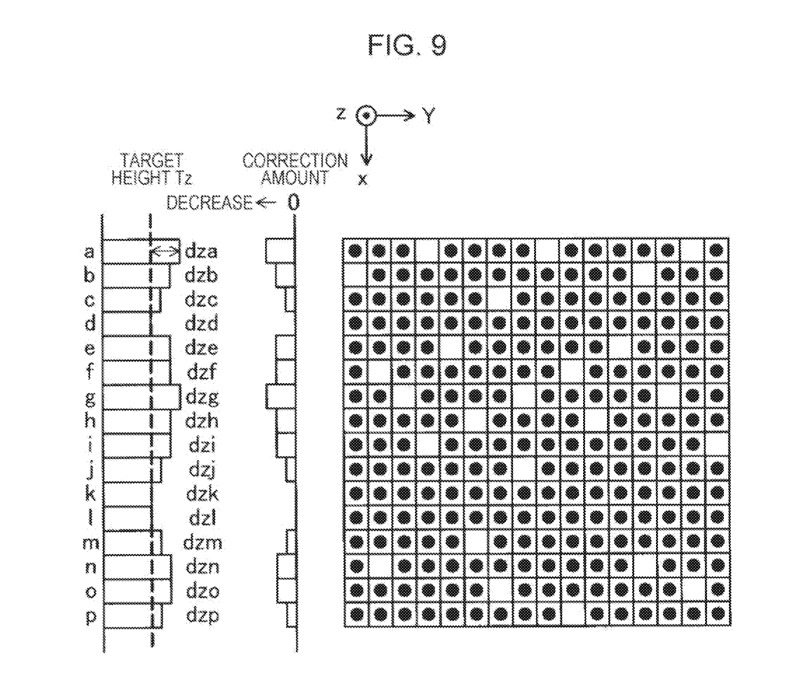

The first method is a method of reducing the number of ink droplets by thinning dots. FIG. 9 is an explanatory diagram illustrating the processing of reducing the number of ink droplets in the first method. In the first method, a target height Tz of each dot after ink solidification is set to be the lowest height. The target height Tz after ink solidification and, differences dza to dzp between the height of each dot and the target height Tz are pre-measured, and stored in the memory 16 as nozzle data. In this example, the height of the dot of an ink droplet, which is discharged through the nozzle d and formed, is a reference. The nozzle used for the reference does not need to be stored in the memory 16. This is because the nozzle having zero difference with the target height Tz can be identified as the reference. In this case, the amount of ink droplets discharged through any of other nozzles is larger than the amount of ink droplets discharged through the nozzle d. Thus, the discharge data generator 95 reduces the amount of ink discharged through other nozzles by thinning the number (simply called “number”) of discharge of an ink droplet through other nozzles based on the nozzle data. In FIG. 9, the dot of an ink droplet is formed in each voxel indicated by a black circle, and each voxel without a black circle is a thinned voxel in which a dot of an ink droplet is not formed. Although the dot of an ink droplet discharged through the nozzle d is not thinned, the dot of an ink droplet discharged through the nozzle a is thinned for three times. It is to be noted that the example illustrated in FIG. 9 shows the presence and absence of formation of a dot in a certain layer, and in a different layer, positions (positions for thinning) at each of which the dot of an ink droplet is not formed are different from the positions illustrated in FIG. 9. Therefore, when a large number of layers are formed, the positions at which the dot of an ink droplet is not formed are distributed, and the sum of the heights of dots are uniformalized. Therefore, the difference between the amounts of discharged ink through the nozzles can be reduced, and the shape reproducibility can be improved.

The number of thinning m can be, for instance, calculated as follows. When the nozzle a is taken for an example, m is determined such that daz/Tz=m/M is satisfied. The Tz is a target height and daz is the value obtained by subtracting the target height Tz from the height of actual dots. M is the number of voxels, which the unit of processing, in the y direction. In the example of FIG. 9, the value of M is 16. The discharge data generator 95 can determine the positions for thinning using a dither mask threshold, for instance. For instance, when three dots are thinned, the discharge data generator 95 thins the dots up to the third position in the first layer in descending order of the threshold value in the y direction of the dither mask, and thins the dots at the fourth to sixth positions in the second layer in descending order of the threshold value in the y direction of the dither mask. In the third layer, the dots at the seventh to ninth positions in descending order of the threshold value in the y direction of the dither mask are thinned. In this manner, the positions at which the dot of an ink droplet is not formed can be distributed.

Second Method

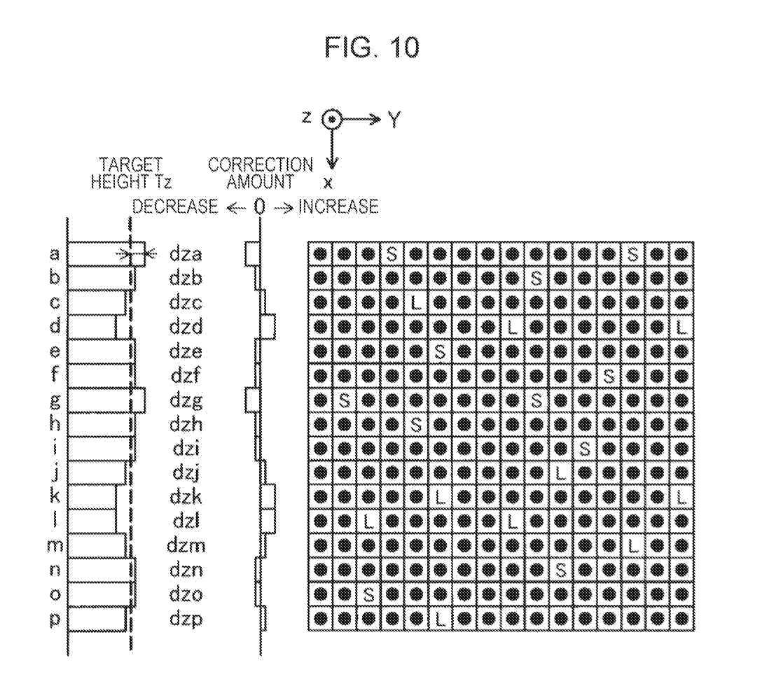

The second method is a method of reducing the amount of ink by changing the size (dot size) of an ink droplet. FIG. 10 is an explanatory diagram illustrating the processing of reducing the amount of ink in the second method. In the second method, the target height Tz of the dot after ink is solidified is set to the average dots height when the dot of an ink droplet is formed by a medium dot. The target height Tz after ink solidification and, differences dza to dzp between the height of each dot and the target height Tz are similarly pre-measured, and stored in the memory 16 as nozzle data. In this case, the amount of ink droplets discharged through the nozzles may be larger than the average or smaller than the average. The discharge data generator 95 changes part of the sizes (dot sizes) of ink droplets discharged through the nozzles based on the nozzle data. In FIG. 10, each voxel indicated by a black circle is a position at which a medium dot of ink is formed. In FIG. 10, each voxel indicated by “L” is a voxel in which a medium dot is changed to a large dot. When the amount of ink discharged through the nozzles is smaller than the average, the discharge data generator 95 increases the amount of ink by changing the sizes (dot sizes) of ink droplets included in part of the dots from a medium dot to a large dot. In FIG. 10, each voxel indicated by “S” is a voxel in which a medium dot is changed to a small dot. When the amount of ink discharged through the nozzles is larger than the average, the discharge data generator 95 decreases the amount of ink by changing the sizes (dot sizes) of ink droplets included in part of the dots from a medium dot to a small dot. The example illustrated in FIG. 10 is an example of changing the sizes of the dots in a certain layer, and when a layer is different, the positions at which the size of a dot is changed are different. Therefore, when a large number of layers are formed, the positions at which a medium dot is changed to a large dot or a small dot are distributed, and the sum of the heights of dots are uniformalized. Consequently, the difference between the amounts of discharged ink through the nozzles can be reduced, and the shape reproducibility can be improved. The number of dots to be changed can be determined by the absolute value of the differences from the target height Tz. It is to be noted that the discharge data generator 95 can calculate the number of dots to be changed in the same manner as the first method, and also can determine the position at which the size of a dot is to be changed in the same manner as the first method.

Third Method

The third method is a method of adding a dot. In the third method, some voxels are generated in advance, to which the dot of an ink droplet is not assigned in halftone processing, by decreasing a dot recording rate, and the amount of ink is increased by assigning a dot to each of the some voxels to which the dot of an ink droplet is not assigned.

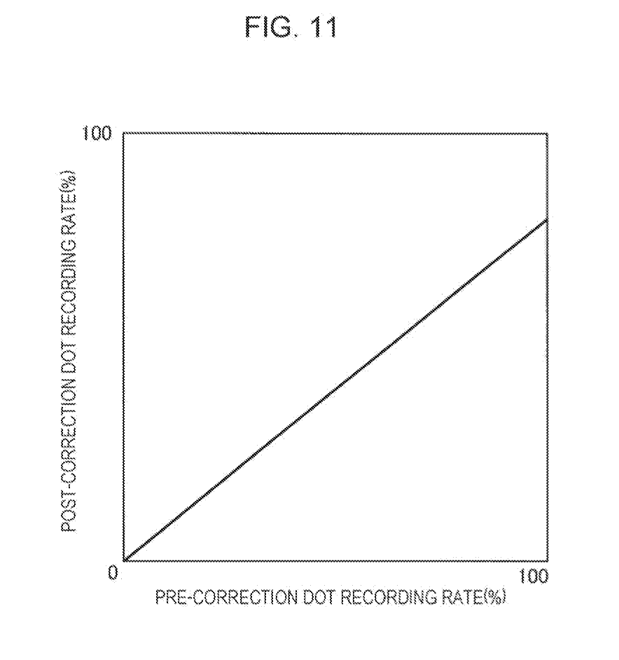

FIG. 11 is an explanatory diagram illustrating the processing of converting a dot recording rate in the third method. In the third method, the discharge data generator 95 first decreases the dot recording rate for each color of YMC color data obtained by converting RGB data. When halftone processing is performed with a decreased dot recording rate, a voxel to which a dot is not assigned occurs.

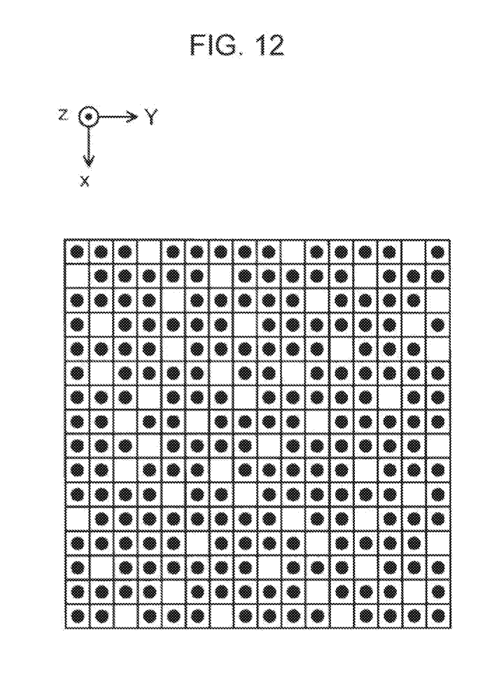

FIG. 12 is an explanatory diagram illustrating the voxels to each of which a dot is assigned and the voxels to each of which a dot is not assigned in the third method. In FIG. 12, each voxel indicated by a black circle is a voxel to which the dot of an ink droplet is assigned by halftone processing, and each voxel without a black circle is a voxel to which the dot of an ink droplet is not assigned. As described with reference to FIG. 11, voxels to which the dot of an ink droplet is not assigned occur because of the decreased dot recording rate.

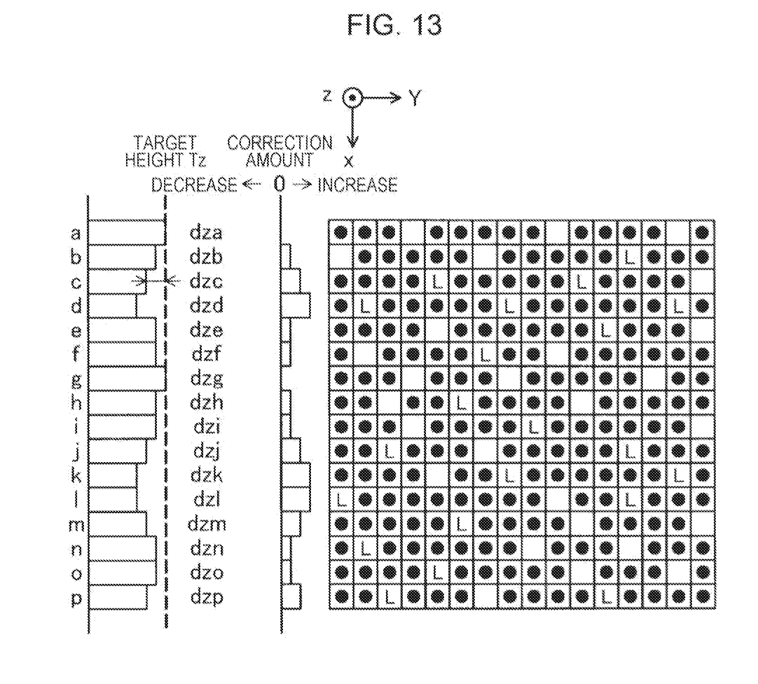

FIG. 13 is an explanatory diagram illustrating the processing of reducing the amount of ink in the third method. The discharge data generator 95 sets the target height Tz after ink solidification to the lowest height based on the nozzle data. Therefore, to achieve the target height Tz, the discharge data generator 95 adds the amount of ink, that is, increases the amount of ink droplets. Since the dot recording rate is decreased in this method, voxels to which the dot of an ink droplet is not assigned occur. Therefore, the discharge data generator 95 increases the amount of ink by assigning a dot to the voxels to which the dot of an ink droplet is not assigned. The example illustrated in FIG. 13 is an example of adding dots to a certain layer, and when a layer is different, the positions at which a dot is added are different. Therefore, when a large number of layers are formed, the positions at which a dot is added are distributed, and the sum of the heights of dots are uniformalized. Consequently, the difference between the amounts of discharged ink through the nozzles can be reduced, and the shape reproducibility can be improved.

In the second method, three types of dots, that is, a large dot, a medium dot, and a small dot are assigned by the discharge data generator 95. However, the third method is applicable to the case where the dot size has one type.

It is to be noted that in another aspect of the third method, the discharge data generator 95 may assign a large dot, a medium dot, and a small dot according to the amount of ink to be replenished. In this case, the amount of ink to be added can be finely adjusted.

As described above, by using one of the first to third methods, the discharge data generator 95 can decrease or increase, that is, change the amount of the ink to be discharged through the nozzles Nz in a predetermined period, for instance, in a period in which a predetermined number of layers are formed, and thus can reduce the difference between the amounts of discharged ink through the nozzles, and can improve the shape reproducibility. Also, the first to third methods may be used in combination.

Other Modifications

The present technique is applicable to a three-dimensional object modeling device that uses a liquid other than cyan ink, magenta ink, yellow ink, white ink, black ink, and clear ink, for instance. For instance, gray ink, metallic ink (ink that exhibits metallic luster) are also usable. It goes without saying that the present technique is also applicable to a three-dimensional object modeling device that does not use part of cyan ink, magenta ink, yellow ink, black ink, white ink, gray ink, metallic ink, and clear ink. Multiple types of dots formed by a dot formation unit may include dots with one of more colors of cyan, magenta, yellow, black, white, gray, and metallic color.

The ink discharged from the head unit may be a thermoplastic liquid such as a thermoplastic resin. In this case, the head unit may heat and discharge the liquid in a molten state. Also, the curing unit may be a section of the three-dimensional object modeling device, in which a dot with liquid from the head unit is cooled and solidified. In the present technique, “curing” includes “solidifying”. Also, the modeling ink and the supporting ink may use liquids having different types of curing/solidifying process. For instance, an ultraviolet curable resin may be used for the modeling ink, and a thermoplastic resin may be used for the supporting ink.

The curing unit 61 may be mounted in the carriage.

A model processing device may forms a model layer by solidifying powder materials covered in layers using a curable liquid, and may model a three-dimensional object by stacking the formed model layer.

Also, the three-dimensional object modeling device is not limited to an inkjet device that discharges liquid and forms dots, and may be an optical model device that forms cured dots by irradiating a tank filled with an ultraviolet curable liquid resin with an ultraviolet laser, or a sintered powder lamination device that forms sintered dots by irradiating powder materials with a high-output laser beam.

Also, a configuration obtained by mutually replacing or changing a combination of the configurations disclosed in the example described above, and a configuration obtained by mutually replacing or changing a combination of a publicly known technique and the configurations disclosed in the example described above are also practicable. The invention also includes these configurations.

The entire disclosure of Japanese Patent Application No. 2017-062328, filed Mar. 28, 2017 is expressly incorporated by reference herein.

What is claimed is:

1. A three-dimensional object modeling device that uses ink which is solidified after being discharged and becomes part of a three-dimensional object as a three-dimensional dot, the three-dimensional object modeling device comprising:
a recording head including a plurality of nozzles each of which discharges a droplet of the ink;
a memory that pre-stores nozzle data for each of the plurality of nozzles, the nozzle data corresponding to a volume of the dot or an amount of increase or decrease in the volume of the dot after the discharged droplet of the ink is solidified;
a modeling data generator that generates modeling data for modeling the three-dimensional object; and
a discharge data generator that generates ink discharge data for instructing discharge of the ink droplet for each of the plurality of nozzles in accordance with the pre-stored nozzle data based on the generated modeling data so that a total height of the dot in a direction of layering the dot is uniformalized.

2. The three-dimensional object modeling device according to claim 1,
wherein the discharge data generator uniformalizes the total height of the dot in the direction of layering the dot by increasing or decreasing a number of the ink droplet.

3. The three-dimensional object modeling device according to claim 2,
wherein the discharge data generator generates a voxel in advance, to which a dot of the ink droplet is not assigned, by decreasing an amount of gradation data for halftone processing, and
enables an increase in the number of the ink droplet by assigning a dot of the ink droplet to the voxel to which a dot of the ink droplet has not been assigned.

4. The three-dimensional object modeling device according to claim 1,
wherein the discharge data generator uniformalizes the total height of the dot in the direction of layering the dot by changing a size of the ink droplet.

5. The three-dimensional object modeling device according to claim 4,
wherein the discharge data generator generates a voxel in advance, to which a dot of the ink droplet is not assigned, by decreasing an amount of gradation data for halftone processing, and
assigns a dot of the ink droplet with a size in accordance with the nozzle data to the voxel to which a dot of the ink droplet has not been assigned.

6. A method of molding a three-dimensional object, the method comprising:
pre-storing nozzle data for each of a plurality of nozzles, the nozzle data corresponding to a volume of a dot or an amount of increase or decrease in the volume of the dot after a discharged droplet of the ink is solidified;
generating modeling data for modeling the three-dimensional object; and
generating ink discharge data for instructing discharge of the ink droplet for each of the plurality of nozzles in accordance with the nozzle data in the pre-storing based on the modeling data in the generating so that a total height of the dot in a direction of layering the dot is uniformalized.

7. The method of molding a three-dimensional object according to claim 6,
wherein the total height of the dot in the direction of layering the dot is uniformalized by increasing or decreasing a number of the ink droplet.

8. The method of molding a three-dimensional object according to claim 7,
wherein a voxel to which a dot of the ink droplet is not assigned is generated by decreasing an amount of gradation data for halftone processing, and
an increase in the number of the ink droplet is enabled by assigning a dot of the ink droplet to the voxel to which a dot of the ink droplet has not been assigned.

9. The method of molding a three-dimensional object according to claim 6,
wherein the total height of the dot in the direction of layering the dot is uniformalized by changing a size of the ink droplet.

10. The method of molding a three-dimensional object according to claim 9,
wherein a voxel to which a dot of the ink droplet is not assigned is generated in advance by decreasing an amount of gradation data for halftone processing, and
a dot of the ink droplet with a size in accordance with the nozzle data is assigned to the voxel to which a dot of the ink droplet has not been assigned.

11. A control program for a three-dimensional object modeling device, the control program causing a computer to implement a function, the function comprising:
pre-storing nozzle data for each of a plurality of nozzles, the nozzle data corresponding to a volume of a dot or an amount of increase or decrease in the volume of the dot after a discharged droplet of the ink is solidified;
generating modeling data for modeling the three-dimensional object; and
generating ink discharge data for instructing discharge of the ink droplet for each of the plurality of nozzles in accordance with the nozzle data in the pre-storing based on the modeling data in the generating so that a total height of the dot in a direction of layering the dot is uniformalized.
